(19) United States
(12) Patent Application Publication
(10) Pub. No.: US 2004/0010698 A1
(43) Pub. Date: Jan. 15, 2004

(54) Digital certificate system incorporating voice biometric processing

(76) Inventor: Andrew R. Rolfe, Itasca, IL (US)

Correspondence Address: WELSH & KATZ, LTD, 120 S RIVERSIDE PLAZA, 22ND FLOOR, CHICAGO, IL, 60606, US

(21) Appl. No.: 10/448,253

(22) Filed: May 29, 2003

Related U.S. Application Data
(60) Provisional application No. 60/384,185, filed on May 30, 2002.

(51) Int. Cl. H04L 9/00

(52) U.S. Cl. 713/186; 713/175

(57) ABSTRACT

A digital certificate registration and verification system and method incorporate a unique identifier of a voice biometric data profile from an applicant into a certificate. The profile can subsequently be retrieved and compared to a profile from a party initiating a transaction. Results can be incorporated into a decision as to the authenticity of the party that has initiated the transaction.

The benefit of a May 30, 2002 filing date for Provisional Patent Application Ser. No. 60/384,185 is hereby claimed.

### FIELD OF THE INVENTION

The invention pertains to systems and processes for issuing and subsequent use of enhanced digital certificates. More particularly, the invention pertains to such systems and processes which incorporate voice biometric processing for enhanced security during digital certificate issuance and subsequent verification.

### BACKGROUND OF THE INVENTION

Digital certificates are used as sophisticated keys to enhance the security of electronic transactions. For a digital certificate to be trusted in an electronic transaction, it must be assumed that there was a rigorous process applied when the certificate was first issued to verify the identity of the individual who obtained and will be using the certificate. That process typically involves 1) some form of authentication; 2) the creation of the certificate containing specific information identifying the individual, the issuing Certificate Authority (CA), a unique identifier and a validity date range; 3) the signing of that certificate by a trusted CA, and 4) some method of limiting the use of the certificate to only that individual. Usage often is restricted by:

1. The issuance of a shared secret (e.g. a password) to unlock the private key of the digital certificate and/or

2. Simply storing the certificate in a single location where only that individual has access. For example:

a. Stored in a computer's persistent storage, where the computer is located in a physically secured area like a locked office.

b. Stored inside an electronically readable physical token like a smart-card.

When a certificate is used in an electronic transaction, the other party to the transaction places its trust in the certificate and the associated processes for authentication. A problem with many known digital certificates is that trust in the certificate after issuance is based solely on the security of restricted certificate usage (as mentioned above). So if one party can obtain another party's shared secret and/or can gain access to the device where the certificate is stored, the one party can potentially masquerade as another party in an electronic transaction using a digital certificate.

A party to an electronic transaction that is secured by the use of a digital certificate has two known ways of verifying the validity of the certificate at the time of the transaction. The recipient can verify that the certificate is not being used outside its validity date range (reference CCITT Standard X.509). The recipient can check if the issuing CA has revoked the certificate for any reason (reference IETF RFC 2560 of June 1999—X.509 Internet Public Key Infrastructure Online Certificate Status Protocol—OCSP). These checks verify if the certificate itself is still valid For enhanced trust it is important for the recipient to be able to verify that the user of the certificate is actually who the certificate represents them to be. The public portion of a digital certificate can contain secure (i.e. modification would invalidate the certificate) attributes, which can be used for verification purposes. These attributes can include identifying information as basic as name, and address, to more complex information like biometric data. For this data to be used by the recipient, it must be in the public portion of the certificate, and is therefore easily accessible by others as well.

Including biometric data within the certificate itself allows, at any time, for positive verification that the user of the certificate is the same person to whom the certificate was issued. There are several challenges in using biometric data in a digital certificate.

One challenge is to be able to collect the data, both at time of issuance and at time of use. Another is coordinating the type, structure and encoding of the biometric data between the issuing system and the validating system.

Since the biometric data is stored directly in the public portion of the certificate, it must be protected (encoded) in a way so that access to the data does not allow for simulation or regeneration of the biometric. There are also challenges regarding the long-term use of biometrics, since in several cases the physical characteristics that the biometric represents are known to change over time.

Biometric data capture requires the physical presence of the individual. For online, real-time issuance or verification of a digital certificate, this physical presence can only be assured if the computer or system the individual is using to initiate the transaction has the necessary equipment to 1) capture the biometric; 2) to protect the biometric from tampering; and 3) in the case of verification, to make the comparison in a secure and trusted manner.

There thus continues to be a need for systems and methods for securely acquiring, storing, and comparing biometric data in digital certificate applications. Preferably, the certificate applicant would not have to go to a special location to provide such data. Further, since some forms of such data are known to vary as the applicant ages, it would be preferable if older samples of biometric data could be adapted in response to changes in securely acquired subsequent samples.

### BRIEF DESCRIPTION OF THE DRAWINGS

FIG. 1 is a block diagram illustrating a registration system implemented as a service in accordance with the invention;

FIG. 2 is a block diagram of a verification system implemented as a service in accordance with the present invention;

FIG. 3 is a block diagram of the system of FIG. 1 implemented with additional software to provide the respective services on a non-shared, non-public basis;

FIG. 4 is a block diagram of the system of FIG. 2 implemented with additional software to provide the respective services on a non-shared, non-public basis;

FIG. 5 is a registration system sequence diagram; and

FIG. 6 is a verification system sequence diagram.

### DETAILED DESCRIPTION OF THE PREFERRED INVENTIONS

While this invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

This digital certificate process incorporates two substantially different communications networks. One network, which could be implemented with a plurality of interconnected computers such as the worldwide web, can be used by an applicant seeking a certificate to contact an issuer or an issuer's agent. In response to queries from the issuer, the applicant provides identifying information. For identity confirmation, the issuer can obtain from a data base or can request from the applicant a voice network identifier, for example a phone number, of a voice input device adjacent to the applicant at that time. The issuer can also provide random, temporary identifying or authenticating information to the applicant via this network.

To strengthen the trust in the voice network identifier being used, local or third party databases can be searched for data associated with the subject voice network identifier. Information associated with the subject voice network identifier can be analyzed for similarities with the other identifying information gathered or known. That analysis may be used for further verification that this voice network identifier belongs to (and is therefore being answered by) the person whose identity is being verified.

The issuer then uses a second, out of band, voice network, the switched telephone network, for example, or any other out of band communications network, to contact the applicant in parallel with the on-going succession taking place via the first network. The applicant then audibly feeds the random, temporary identifying information back to the issuer via the second network. If the information from the two networks compares, then this verifies that the same individual is connected to both networks.

Information received from the applicant via the voice network is analyzed using speech recognition processes to ascertain the similarity between the information fed back and that provided to the applicant. In addition, a user voice biometric profile (from here on called a voiceprint) is created and retained. In a processed form the voiceprint, via a unique identifier (from here on called a voiceprint identifier or VPID) can be incorporated into the certificate for authentication purposes. The certificate can then be issued to the applicant.

When use is subsequently made of the certificate, in commerce for example, a third party that is considering accepting the certificate can extract voice identifying information therefrom. It can then forward same along with an appropriate voice network identifier to an authenticating service, which could be the certificate issuer, or to internal software for authentication.

The applicant is then contacted using the voice network identifier and the voice network, for example a phone number and telephone system. Additional voice information is obtained and processed. It is not necessary that the voice network used in this verification process, nor the voice network identifier, be the same as what was used in the initial registration.

The newly processed voice information can be compared to the voice information associated with the certificate. The results can be used by the third party to make a decision as to the authenticity of the party that initiated the transaction.

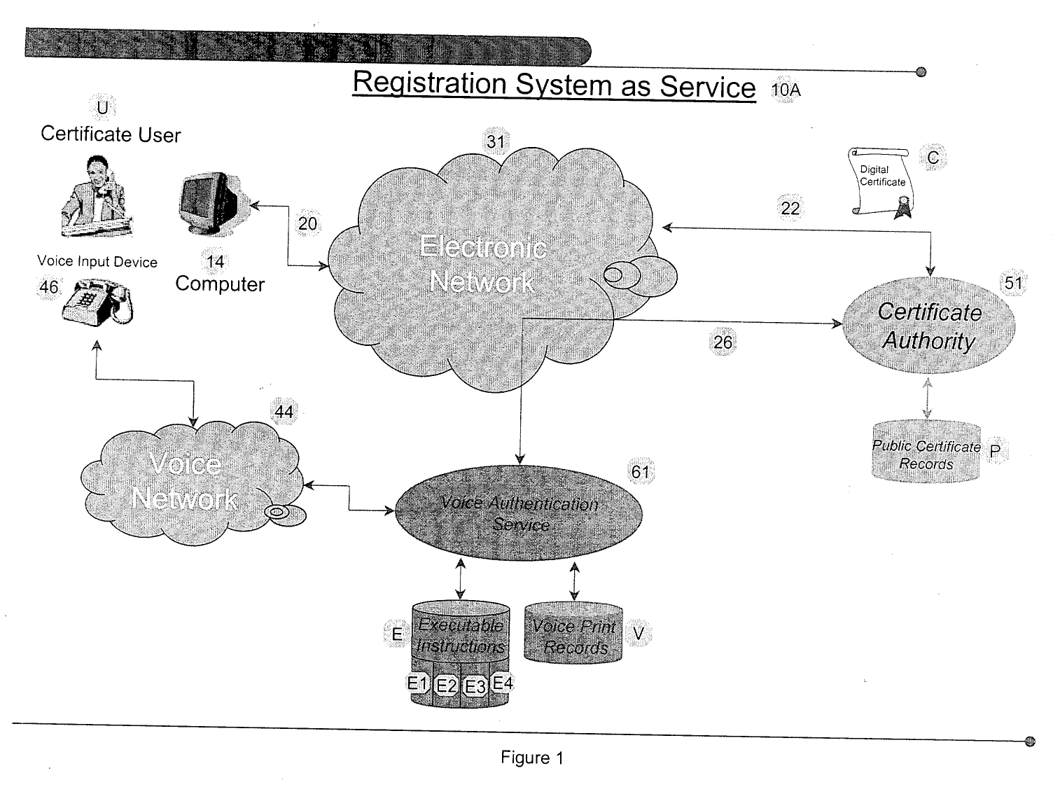

The first embodiment is a registration system FIG. 1, a system 10A (with a voice authentication service) that uses a voice network 44 to provide a real-time, interactive and largely self-service method of enhancing digital certificates with a voice biometric data identifier. System 10A is based on the coordination of actions between an electronic network 31, for example the Internet, and a different, out of band voice network 44, such as the Public Switched Telephone Network (PSTN). This system may be used in real-time for both the issuance of a digital certificate enhanced with an identifier of stored voice biometric data, and, the subsequent re-issuance of the digital certificate. Re-issuance is based on the lifespan of the digital certificate, which is typically dictated by policies of the issuing Certificate Authority (CA) 51.

When an individual U wishes to obtain a digital certificate for electronic commerce, he/she contacts a CA's software driven web site 51 (or another institution like a bank or their employer, who indirectly contacts the CA) via the electronic network 31 and requests a certificate. The CA 51 then executes pre-stored instructions and presents a form to the individual U over a secure network connection. Data as required is collected to be recorded in the certificate (e.g. name, address, organization), potentially including a phone number where they will be able to be reached.

If the individual is known to the institution, such as an employer—employee (or more generally institution—member) relationship, one or more shared secrets can also be collected that can help verify the identity of the individual. In such a known relationship, the phone number can also be required to be a phone number that is already known by the institution (e.g. work phone). This will increase the security of the procedure, but is not a limitation of this invention.

Once the data has been collected, a number or character string (typically of at least 8 characters) is randomly generated (or randomly selected from the set of known data) and displayed to the individual over the secure network connection. The randomness of the data is important to eliminate guessing or presupposing the data.

The issuing CA 51 then sends a request to the Service 61, at another web site for example, containing the phone number and the random string. The Service 61 would execute pre-stored instructions E1-E4 and would use internal databases or external third-party databases to obtain information (also referred to as data lookup) about the owner of the supplied phone number and the telephone's approximate location. At the same time, a telephone call would be placed to that number via network 44.

When the individual U answered the phone 46, he/she would be requested by the Service 61 to speak the randomly generated string, one character at a time. While the individual is speaking, the Service 61 can use speech recognition processing, pre-stored instructions E2, to verify the individual U is speaking the same string that was requested. Since it was randomly selected this sequence is used to verify the individual on the network connection is the same individual answering the telephone.

Optionally, the Service 61 could also ask the person to speak his/her full name clearly. A recording of the name being spoken would be stored using pre-stored instructions E3. While the individual is speaking, the Service 61 can also be analyzing his/her voice and creating a voiceprint, similar to a fingerprint or a written signature, using pre-stored executable instructions E4. The voiceprint is a digital representation of the unique characteristics of the user's voice and vocal tract.

The voiceprint is stored in a secure location V by the Service 61 and is given a globally unique identifier (Voice Print ID or VPID). If there are problems with recognition or with the quality of the voiceprint, the System will execute additional instructions and request additional speech data until a voiceprint of appropriate quality is obtained or the System rejects the registration attempt.

Upon completion, the Service 61 will return to the CA 51 the success or failure of the registration, the data found associated with the phone number, the data recognized during the speech interaction, and the VPID if successful. The CA 51 or the requesting organization can execute pre-stored instructions and use the returned data to further authenticate the individual. In this scenario the Service 61 stores the voiceprint and name recording in its own secure storage V. Another alternative would be to return the data and recordings for secure storage at the CA 51.

If the CA 51 receives a successful response from the Service 61, it will execute pre-stored instructions and add the phone number and biometric identifier, the VPID, to the certificate data, create the certificate C, and digitally sign it to secure it from tampering. The certificate C is then returned to the individual requester U to be installed in their equipment and is also typically stored in a public directory P where it can be verified by anyone who may be involved in an electronic transaction with that individual in the future.

If multiple voice networks, with different quality characteristics are used to contact individuals requesting certificates, for example a private cellular network or the PSTN, multiple voiceprints can be collected using the process described above. Each voiceprint will be stored V associated with the same individual and the same VPID, but distinguished by the voice network identifier.

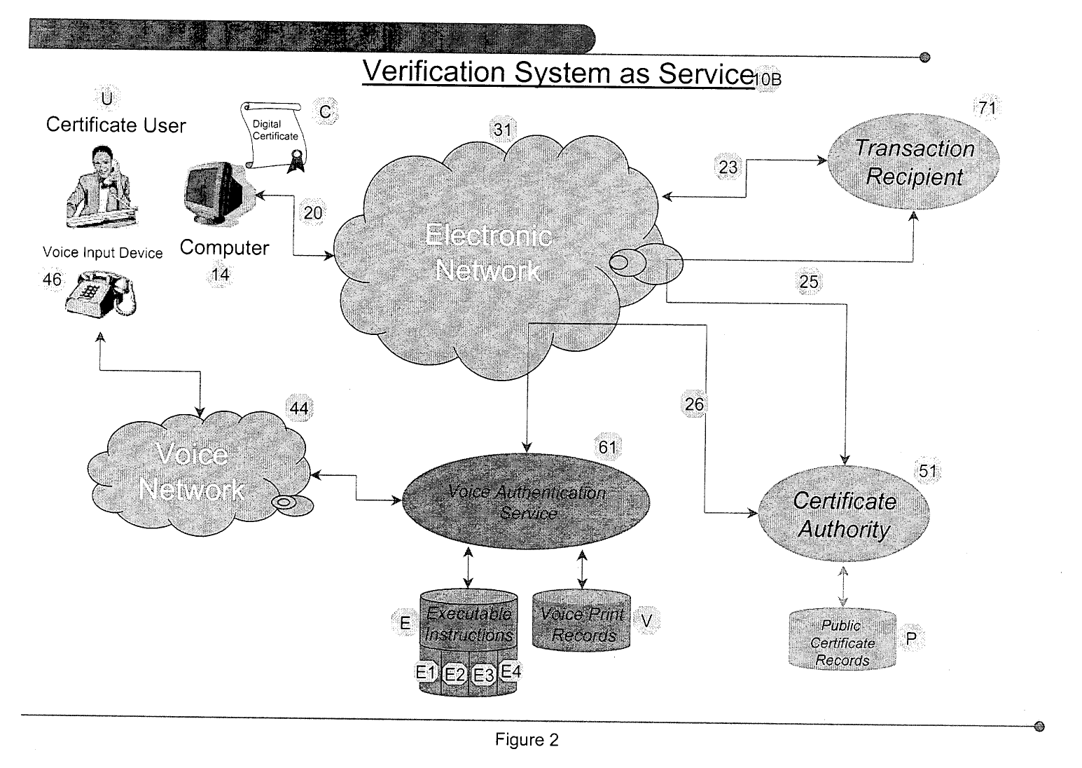

The second embodiment is a verification system 10B, FIG. 2, configured with a voice authentication service, using a voice network 44, as an out-of-band communications link. The enhanced digital certificate C, and one or more voiceprints V collected during the registration process 10A above provide a real-time, interactive and largely self-service method of verifying the actual user of a digital certificate. At some future date, see FIG. 2, third party 71 is sent a transaction that is digitally signed using the certificate C created above, FIG. 1. The third party 71 can access the digital certificate, which is attached to the signed transaction or available in a public directory P.

Using the public data in the certificate, the third party 71 can verify 1) the certificate has not been tampered with; 2) the CA 51 that signed the certificate is a trusted CA; 3) the certificate is not being used outside its valid date range; and 4) the CA has not revoked the certificate before its expiration. If the transaction is of sufficient importance to also require verification of the user U of the certificate (for example a high value purchase), a request can be sent to the Service 61 at this point, again over a secure network connection.

The request could come from the third party recipient 71 of the electronic transaction directly, or it could come indirectly through the issuing CA. The only requirement is that the request be handled in a secure manner. In this exemplary scenario, the third party 71 handles the request directly since it is the party at risk, and therefore has a vested interest in ensuring security.

The request to the Service 61 would contain a phone number and the VPID from the certificate C, as well as some pertinent data from the transaction (like the value of the purchase). The phone number could be obtained from many sources and is not required to be the same phone number used during registration. The phone number can also be used by the Service 61 to select which voiceprint to use, if multiple voiceprints are stored per VPID.

For an interactive, online purchase, the end user U would be requested to enter the phone number where he/she could be reached at that time. For a non-interactive session, the phone number recorded in the certificate or a phone number the third party had on record for the individual could be used. This mimics standard business practices where a manual phone call is often placed to the business contact of record before an important transaction is approved.

After receiving the request, data lookup would occur and the Service 61 would place the phone call. There are procedures, known to those of skill in the art, to ensure the phone call reaches the individual who was issued the certificate. In the case of a non-interactive session, an optional full name recording taken during registration can become useful. Once the phone call has been answered, a series of prompts, for example as below, could be spoken over the telephone connection:

1. Prompt: “This call is for”

2. Full name recording played

3. Prompt: “If you are”

4. Full name recording played

5. Prompt: “please press the star key, otherwise please transfer this call to”

6. Full name recording played

These prompts would be repeated until the Service 61 detects the specified key being pressed from the phone keypad or the System retry limit is exceeded. Once the individual identified himself or herself by pressing the specified key, the Service 61 would execute pre-stored instructions to prompt the individual U to speak some data. The data could simply be the phone number, or the value of the purchase one digit at a time. The only requirement is that the speech be of sufficient length to allow comparison with the stored biometric data, the voiceprint records V.

When sufficient voice data has been obtained to determine a match or non-match, service 61 executes pre-stored instructions which end the phone call. The success or failure of the biometric match, the data found associated with the phone number, and the data recognized during the speech interaction can all returned to the third party 71 from service 61 or the CA 51 by the execution of other pre-stored instructions. Enough information should now be available to enable the third party 71 to make an authentication decision relative to the individual initiating the transaction.

If there is a strong enough biometric match during any such verification, the Service 61 or Recipient 71 can execute additional instructions and choose to adapt the pre-stored voiceprint at that point. As a person ages their voice can change. This adaptation can allow the voiceprint to change with the users voice over time, allowing for more accurate biometric comparisons in the future. This adaptation can also occur when the certificate is approaching its expiration date.

The CA 51 or the institution which issued the certificate, and therefore who has a record of the validity period of the certificate, can, by executing other pre-stored instructions, send a notification to the individual U when the expiration date is approaching. This notification would encourage the individual U to re-register using essentially same processes as described above, FIG. 1, for registration. A similar randomly generated or selected string would be used for speech comparison.

Instead of creating a new voiceprint, the voice would be compared to the VPID on record. If there was a sufficiently strong voice biometric match, the voiceprint referenced by the existing VPID can be adapted as necessary. The validity range of the certificate would also be updated to cover an additional period.

This system and method provide solutions for many of the complexities of issuing digital certificates containing biometric data:

1. The system requires no special biometric equipment to be used by the digital certificate issuer, or the certificate user, be it the user who was issued the certificate or the user who is the recipient of an electronic transaction secured by the certificate.

2. The system does not require physical presence of the individual being authenticated other than access to a voice input device, for example a telephone.

3. A coordinated method of capturing the biometric sample produces data in a form that is compatible between issuance and verification.

4. The actual biometric data is not stored directly in the digital certificate, to ensure the security of the biometric. Instead, a globally unique identifier or representation is stored which can be later interpreted by the System.

5. Since the biometric data is not actually stored in the certificate, the biometric data can change or adapt as the individual and their physical characteristics change over time.

6. The biometric data is stored in a centralized location that can be secured to any degree necessary for the particular application.

7. Since the biometric data is stored in a centralized location, the VPID can be associated with any number of voiceprints without affecting the size of the certificate.

8. The system can be fully automated.

9. The system provides an audit trail including actual voice recordings, which provides a historical record, of the creation, and all the uses and adaptations of the voice biometric data, for the potential prosecution of attempted misuse of the system.

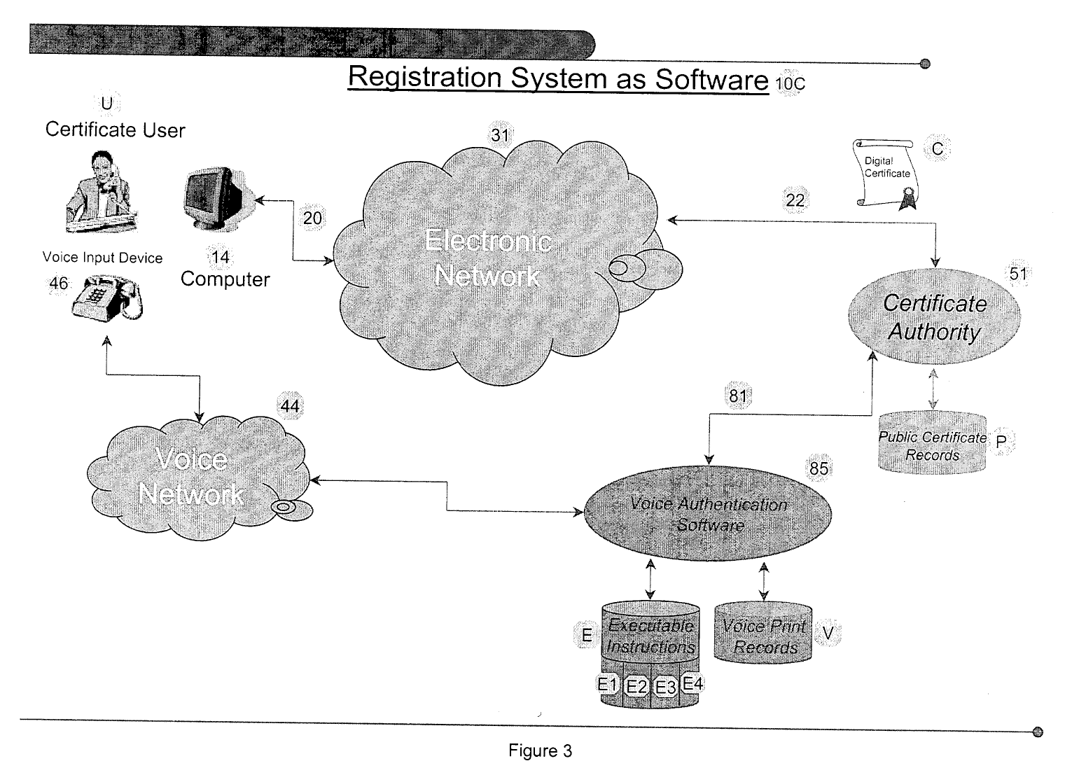

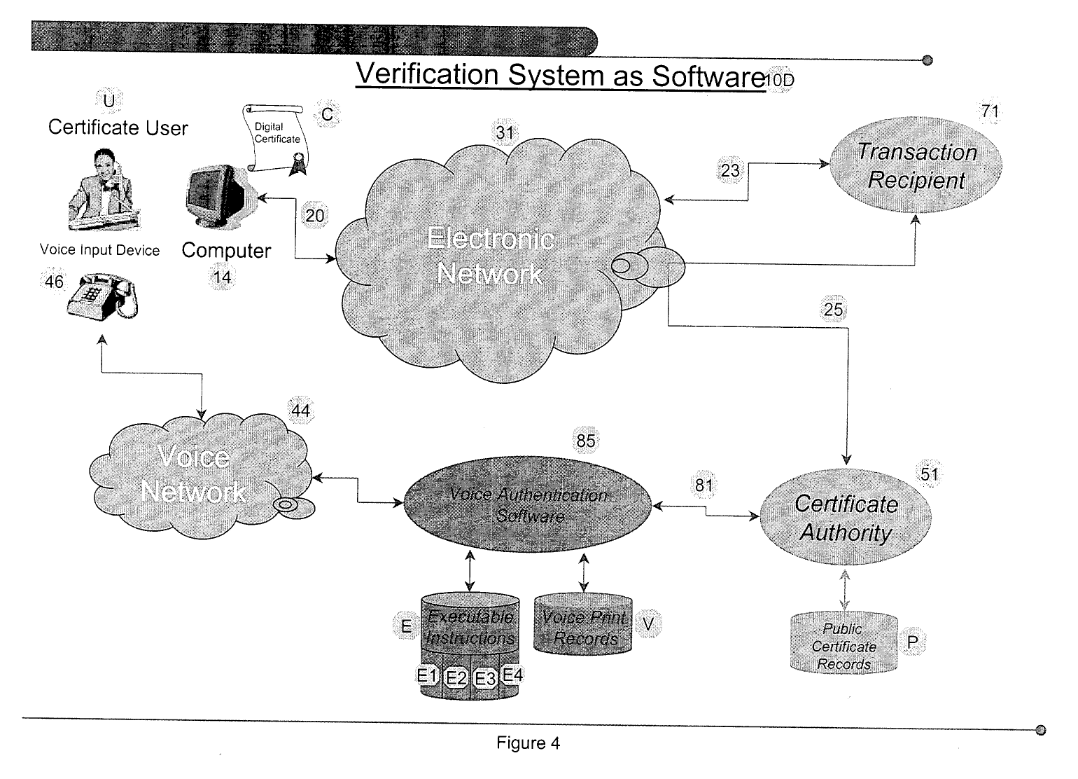

As an alternative to the embodiments depicted in FIG. 1 and FIG. 2, Voice Authentication software 85 could be installed at the CA site 51, as in FIG. 3 and FIG. 4 respectively instead of at a site operated by an outside service. The only substantial difference between the two embodiments is that the components (85, E1-E4, V) and communications 81 are held private to the CA in FIG. 3 and 4. They are a shared service for multiple CAs over a shared network 26 in FIG. 1 and 2.

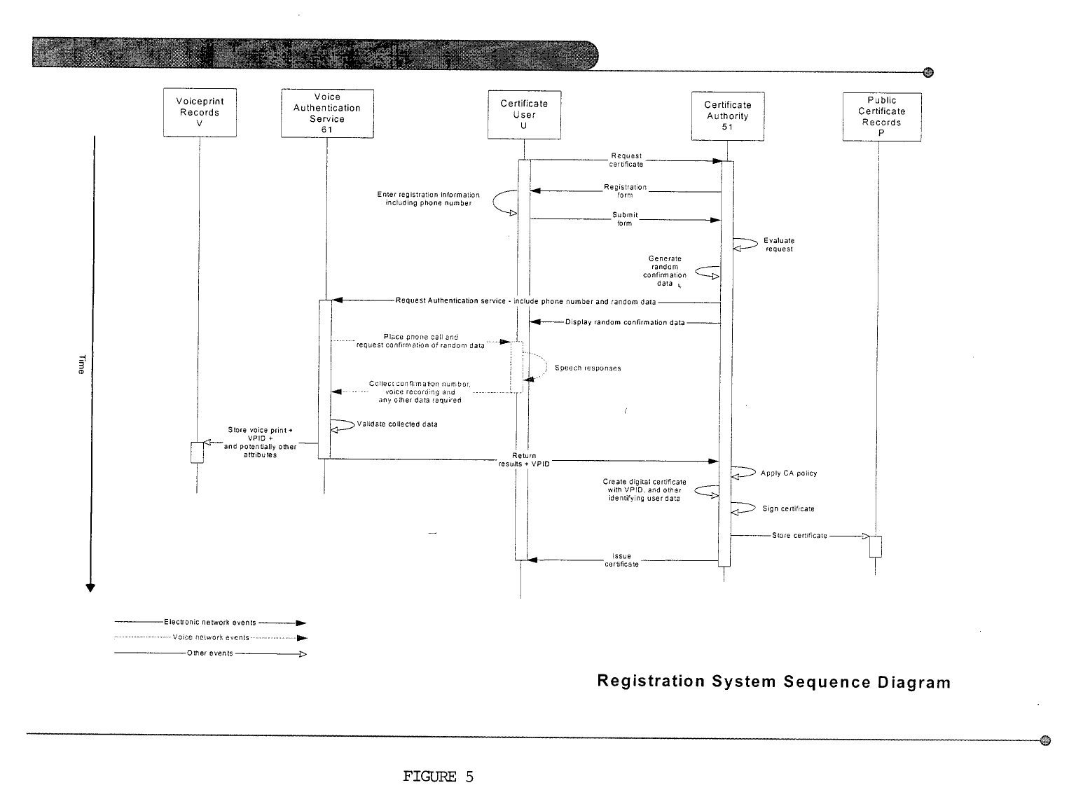

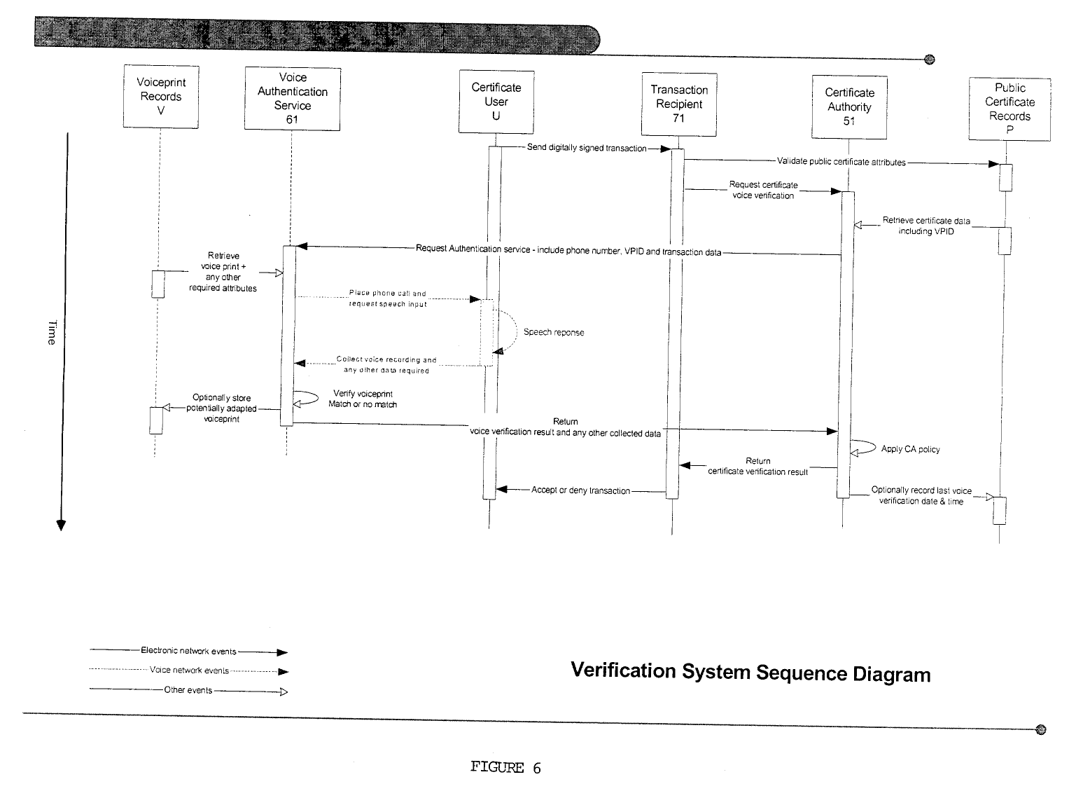

Those of skill in the art will understand that the registration sequence diagram of FIG. 5 illustrates an exemplary process of issuing and registering a digital certificate to a requester or User. FIG. 6 is a verification system sequence diagram illustrating steps as a function of time for verifying that a User is authorized to use a digital certificate.

It will be understood that the phrase “executable instructions” includes instructions directly executable by a processor as well as those that might be interpreted by another program. Further, “instructions” includes both source code and executable instructions. Finally, “software” includes source or object code without limitation. Software or instructions can be pre-recorded on a selected computer readable medium, for example a magnetic or an optical medium.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A method of issuing a digital certificate comprising:
providing a first network connection;
collecting at least biometric data from an applicant via the network connection for incorporating into a digital certificate;
obtaining an identifier associated with the applicant for a terminal on another network;
forwarding identification information, via the first network, to the applicant;
receiving as feedback via the another network, the identification information from the applicant;
evaluating the information received from the applicant to establish its similarity to the identification, information, and, if identical enough, obtaining an applicant specific indicium in real-time from the applicant; and
combining a representation of the applicant specific indicium with the biometric data for use in defining the certificate.

2. A method as in claim 1 which includes combining issuing authority indicia with the combined applicant specific indicium and biometric data.

3. A method as in claim 2 which includes issuing the certificate.

4. A method as in claim 3 wherein the issuing step includes making a representation of the certificate available to third parties for subsequent use.

5. A method as in claim 3 wherein the issuing step includes providing a representation of the certificate to the applicant for subsequent use.

6. A method as in claim 1 wherein the first network comprises a plurality of network service providers wherein user communication is substantially carried out in a non-audible format.

7. A method as in claim 6 wherein the other network comprises a public telephone network wherein user communication is substantially carried out audibly.

8. A method as in claim 7 wherein the identifier comprises an applicant's telephone number.

9. A method as in claim 7 wherein the receiving step comprises receiving audio via the telephone network from the applicant.

10. A method as in claim 9 wherein the evaluating step comprises evaluating received audio.

11. A method as in claim 9 wherein the audio comprises applicant's speech and including carrying out speech recognition processing with respect to received audio.

12. A method as in claim 11 which includes placing a call via the telephone network to the applicant while the applicant is providing data via the first network.

13. A method as in claim 11 which includes comparing current audio to previously processed audio, and responsive thereto, adapting the prestored representation.

14. A method as in claim 13 which includes modifying the previously issued certificate in accordance with an adapted representation.

15. A method as in claim 1 which includes accessing pre-stored data bases to obtain additional information relative to the applicant.

16. A method as in claim 1 which includes obtaining a current sample of applicant's speech and conducting analysis thereof.

17. A method as in claim 16 which includes comparing the analyzed current sample to a pre-stored prior sample.

18. A method as in claim 17 which includes carrying out a verification process using at least the current sample.

19. A method as in claim 18 which includes making a determination to permit a requested transaction based on the results of the verification process.

20. A system comprising:
instructions executable at a respective processor for receiving a request for a digital certificate from an applicant via a first communications link;
instructions executable at a respective processor for requesting information from the applicant via the link;
instructions executable at a respective processor for producing and forwarding authentication information to the applicant;
instructions executable at a respective processor for obtaining contact information associated with the applicant relative to a second link;
instructions executable at a respective processor for contacting the applicant, via the second link;
instructions executable at a respective processor for analyzing audible responses from the applicant received via the second link and authenticating the applicant in response thereto;
instructions executable at a respective processor for forming a binary representation of at least part of the audible responses from the applicant; and
instructions executable at a respective processor for combining the binary representation with other applicant related information to form a digital certificate.

21. A system as in claim 20 which includes executable instructions for issuing the certificate to the applicant.

22. A system as in claim 20 which includes executable instructions for posting a representation of the certificate at a publicly available site.

23. A system as in claim 20 which includes executable instructions for responding to a third party inquiring as to the authenticity of the issued certificate.

24. A system as in claim 23 which includes executable instructions for providing authenticity related information pertaining to the certificate to the third party.

25. A system as in claim 20 wherein the contacting instructions comprise instructions for communicating via both links simultaneously.

26. A system as in claim 25 which includes executable instructions for issuing the certificate to the applicant.

27. A system as in claim 20 which includes instructions executable by a processor for accessing pre-stored data in response to information received from the applicant for use in authenticating the identity of the applicant.

28. A system as in claim 25 which includes executable instructions for posting a representation of the certificate at a publicly available site.

29. A system as in claim 25 which includes executable instructions for responding to a third party inquiring as to the authenticity of the issued certificate.

30. A system as in claim 20 wherein the analyzing instructions comprise instructions for carrying out biometric processing of the audible responses from the applicant.

31. A system as in claim 30 wherein the instructions for forming a binary representation comprise forming an applicant specific profile of the processed audio responses from the applicant.

32. A certificate issuing system comprising:
pre-stored first instructions to receive a telephone number and digitized representations of biometric data;
pre-stored second, instructions to create a digital certificate which includes the phone number and the digitized representations; and
pre-stored third instructions for digitally signing the certificate, the instructions executable by a respective processor.

33. A certificate issuing system as in claim 32 which includes prestored fourth instructions for storing a representation of the certificate at a publicly accessible location.

34. A certificate issuing system as in claim 32 which includes additional pre-stored, instructions, responsive to an inquiry, to compare biometric information as stored in the certificate to currently obtained biometric information.

35. A certificate issuing system as in claim 32 which includes instructions to query at least one pre-stored data base in connection with creating the digital certificate, the instructions being pre-stored in at least one of a computer readable magnetic or optical medium.

36. A certificate system comprising:
a first system for issuing a digital certificate;
a second system for verifying the authenticity of a person desirous of using the certificate, the second system including first software for obtaining a current voice sample from the person,
second software for retrieving a previously stored voice sample for the user and comparing the two samples, and
third software for making an authenticity determination based on the results of comparing the two samples, the software executable by at least one processor.

37. A system as in claim 36 which includes additional software for interrogating at least one pre-stored data base for additional information relative to the person.

38. A system as in claim 36 which includes additional software for updating the previously stored voice sample for the user.

39. A system as in claim 36 where the second and third software are executed by different processors.

40. A system of instructions pre-recorded on at least one computer readable medium comprising:
first instructions for receiving a request for a digital certificate from an applicant via a first communications link;
second instructions for requesting information from the applicant via the link;
third instructions for producing and forwarding authentication information to the applicant;
fourth instructions for obtaining contact information associated with the applicant relative to a second link;
fifth instructions for contacting the applicant, via the second link;
sixth instructions for analyzing audible responses from the applicant received via the second link and authenticating the applicant in response thereto;
seventh instructions for forming a binary representation of at least part of the audible responses from the applicant; and
eighth instructions for combining the binary representation with other applicant related information to form a digital certificate.

41. A system as in claim 40 which includes instructions for issuing the certificate to the applicant.

42. A system as in claim 40 which includes instructions for posting a representation of the certificate at a publicly available site.

43. A system as in claim 40 which includes instructions for responding to a third party inquiring as to the authenticity of the issued certificate.

44. A system as in claim 43 which includes instructions for providing authenticity related information pertaining to the certificate to the third party.

45. A system as in claim 40 wherein the contacting instructions comprise instructions for communicating via both links simultaneously.

46. A system as in claim 45 which includes instructions for issuing the certificate to the applicant.

47. A system as in claim 40 which includes instructions executable by a processor for accessing pre-stored data in response to information received from the applicant for use in authenticating the identity of the applicant.

48. A system as in claim 45 which includes instructions for posting a representation of the certificate at a publicly available site.

49. A system as in claim 45 which includes commands for responding to a third party inquiring as to the authenticity of the issued certificate.

50. A system as in claim 40 wherein the analyzing instructions comprise instructions for carrying out biometric processing of the audible responses from the applicant.

51. A system as in claim 50 wherein the instructions for forming a binary representation comprise forming an applicant specific profile of the processed audio responses from the applicant.

52. A system as in claim 40 where the fourth instructions request the applicant to provide the contact information relative to the second link.

53. A system comprising:
software executable by a respective processor to establish a unique voice biometric data profile from an applicant desirous of obtaining issuance of a digital certificate;
software executable by a respective processor for incorporating at least a representation of the voice biometric profile into the certificate;
software executable by a respective processor for obtaining a current voice biometric profile from a party initiating a transaction for biometric verification;
software executable by a respective processor for comparing the current biometric profile to the representation incorporated into the certificate; and
software executable by a respective processor for verifying the authenticity of the party initiating the transaction.

54. A verification method comprising:
establishing a unique voice biometric profile from an applicant desirous of obtaining issuance of a digital certificate;
incorporating at least a representation of the profile into the certificate;
obtaining a current voice biometric profile from a person initiating a transaction that involves the certificate;
comparing the current voice biometric profile to the representation in the certificate; and
determining if the party initiating the transaction can be expected to be the applicant for the certificate.

55. A method as in claim 1 where the identifier would be obtained from one of pre-stored data or from the applicant.

56. A system as in claim 20 where the instructions for obtaining contact information obtain it from at least one of a pre-stored data source or the applicant.
